(19) United States
(12) Patent Application Publication
(10) Pub. No.: US 2023/0025481 A1
(43) Pub. Date: Jan. 26, 2023

(54) CORN COB PET CHEW

(71) Applicant: IMS TRADING, LLC, Jamesburg, NJ (US)

(72) Inventors: Glen S. AXELROD, Colts Neck, NJ (US); Ajay GAJRIA, Monmouth Junction, NJ (US)

(21) Appl. No.: 17/814,101

(22) Filed: Jul. 21, 2022

Related U.S. Application Data
(60) Provisional application No. 63/203,420, filed on Jul. 22, 2021.

(51) Int. Cl. A23K 10/30; A23K 20/189; A23K 10/20; A23K 20/163; A23K 20/105; A23K 20/111; A23K 50/40

(52) U.S. Cl. CPC A23K 10/30; A23K 20/189; A23K 10/20; A23K 20/163; A23K 20/105; A23K 20/111; A23K 50/40

(57) ABSTRACT

A corn cob type pet chew where the corn cob has improved digestibility. The improved digestibility is provided by digestive enzymes and/or incorporating selected locations of mechanical weaking so that the corn cob will also more readily reduce in size when chewed upon by the animal. The corn cob may also optionally include other additives, such as mineral fillers. The minerals may also assist in digestion.

### FIELD

The present invention is related to a corn cob type pet chew where the corn cob has improved digestibility. The improved digestibility is provided by digestive enzymes and/or incorporating selected locations of mechanical weaking so that the corn cob will also more readily reduce in size when chewed upon by the animal. The corn cob may also optionally include other additives, such as mineral fillers. The minerals may also assist in digestion.

### BACKGROUND

Corn cobs represent the central core of an ear of corn upon which the kernels grow. Corn cobs are also recognized as a renewable resource, in the sense that it is a plant and not based upon a limited supply of a given natural resource. Corn cobs also represent an agricultural waste generated in relatively huge quantities during corn processing.

There have been some reported efforts to utilize corn cobs in a pet chew. For example, reference is made to U.S. Pat. No. 5,296,209 which recites an edible pet chew product having a flexible cellular matrix in which is contained a cellulosic fibrous material such as corn cob fractions. Attention is also directed to U.S. Pat. No. 6,889,628 which is directed to a composition and method for wearing down rodent teeth. A corn cob is soaked in an aqueous solution in which salt and/or vitamins and other nutrients are dissolved or suspended. The cob is subsequently dried leaving a cob infused and impregnated with the salt and/or vitamins or other nutrients. The cob is then provided to a rodent which chews on it, thus wearing down its teeth.

From the perspective of animal digestibility, corn cobs have presented various issues. As corn cobs are a lignocellulose material composed of cellulose, hemicellulose and lignin, corn cobs present as a substrate that is relatively difficult to digest. Accordingly, a need exists to provide corn cobs as a substrate for a pet chew, wherein the digestibility as well as the physical characteristics of the corn cob are modified to provide a more acceptable pet chew for an animal.

### BRIEF DESCRIPTION OF THE DRAWINGS

Reference is now made to the accompanying drawing in which:

FIG. 1 is a front-view of a generally cylindrical corn cob where it includes four (4) pre-weakening cuts.

FIG. 2 provides a perspective view of the corn cob of FIG. 1.

### DETAILED DESCRIPTION

Corn cobs herein are to be understood herein as the central core of an ear of corn upon which the kernels grow. Corn cobs are a lignocellulosic material composed of cellulose, hemicellulose and lignin. Cellulose is built of C6 sugars (e.g. glucose), hemicellulose mainly of the C5 sugars xylose and arabinose. Lignin is made of phenolic macromolecules. The corn cobs contemplated for use herein may preferably include raw or uncooked corn cobs where the corn itself has been removed and/or corn cobs that have undergone cooking (elevated heat treatment). Given their cellulosic composition, corn cobs can present a challenge to the animal digestive system.

Digestive enzymes herein may be understood are those compounds that regulate the chemical reactions that an animal may utilize to digest food in general, and in particular, corn cobs. Such digestive enzymes therefore preferably include cellulase enzymes which degrade cellulose to glucose which then can be absorbed and digested by an animal's digestive system. Cellulases are preferably produced by bacteria and fungi and includes three enzymes such as β-1,4-endoglucanase, cellobiohydrolase and β-glucosidase. Amylase is another digestive enzyme that can hydrolyze glycosidic bonds in starch molecules. Lipase is yet another digestive enzyme that assists in the break-down of fats that can then be absorbed by the intestines. Finally, protease is a digestive enzyme that breaks down the peptide bonds of proteins.

In one embodiment, the present invention is directed at corn cobs that have been exposed to and contain one or more digestive enzymes to assist in animal digestion. The corn cobs herein may therefore be readily exposed to a liquid medium containing one or more digestive enzymes wherein the one or more digestive enzymes are now contained in the corn cob. The digestive enzymes preferably include one or more of cellulase, amylase, lipase and/or protease. The liquid medium in which the corn cobs herein may be exposed to or more preferably soaked, include liquid mediums that contain 0.1% by weight to 75.0% by weight of one or more of the digestive enzymes, more preferably 0.1% by weight to 50.0% by weight, or 0.1% by weight to 25.0% by weight, or 0.1% by weight to 15.0% by weight, or 0.1% by weight to 10.0% by weight, or 0.1% by weight to 5.0% by weight.

The corn cobs themselves may then contain a corresponding amount of the one or more digestive enzymes, depending upon the length of exposure or soaking, such as preferably 0.1% by weight to 50.0% by weight, 0.1% by weight to 25.0% by weight, or 0.1% by weight to 15.0% by weight, or 0.1% by weight to 10.0% by weight, or 0.1% by weight to 5.0% by weight, or 0.1% by weight to 2.5% by weight.

It should be noted that the levels of digestive enzyme(s) that may be present in the corn cob noted above are contemplated to preferably include a mixture of two or more of the preferred digestive enzymes: cellulase, amylase, lipase and/or protease. It is further contemplated that the digestive enzyme(s) that may be present include a mixture of three or more of the preferred digestive enzymes: cellulase, amylase, lipase or protease. Finally, it is further contemplated that the digestive enzymes are a mixture of cellulase, amylase, lipase and protease.

It should also be noted that it is contemplated that since corn cobs as noted are relatively rich in cellulose content, the corn cobs may be prepared with only cellulase as the enzyme ingredient, or cellulase as the primary ingredient of the enzymes selected (i.e. if a plurality of enzymes are selected, cellulase accounts for at least 50% or more of the enzymes selected). Accordingly, when cellulase is the only enzyme selected, the corn cobs preferably include 0.1% by weight to 50.0% by weight cellulase, or 0.1% by weight to 25.0% by weight cellulase, or 0.1% by weight to 15.0% by weight cellulase, or 0.1% by weight to 10.0% by weight cellulase, or 0.1% by weight to 5.0% by weight cellulase, or 0.1% by weight to 2.5% by weight cellulase.

In addition to the use of the digestive enzymes noted above, it is contemplated herein that the corn cobs can include other ingredients to attract or benefit a pet. For example, the liquid mixture noted above that may be used to treat or soak the corn cobs may optionally include one or more flavorants, oils, attractants, minerals, and/or vitamins. Oils may preferably include plant based oils. More preferably the oils may include Hemp oil, CBD, Tea Tree Oil, and Chamomile Oil. The treated corn cob with the one or more digestive enzymes, optionally including one or more flavorants, attractants, minerals and/or vitamins, may then be administered to the animal for chewing. In the corn cobs so prepared, the preferred level of any one or more of the optional flavorants, attractants, minerals and/or vitamins may be 0.1% by weight to 5.0% by weight, or 0.1% to 2.5% by weight, or 0.1% by weight to 1.0% by weight. The minerals may preferably include calcium carbonate and/or magnesium sulfate, which may also assist in digestion.

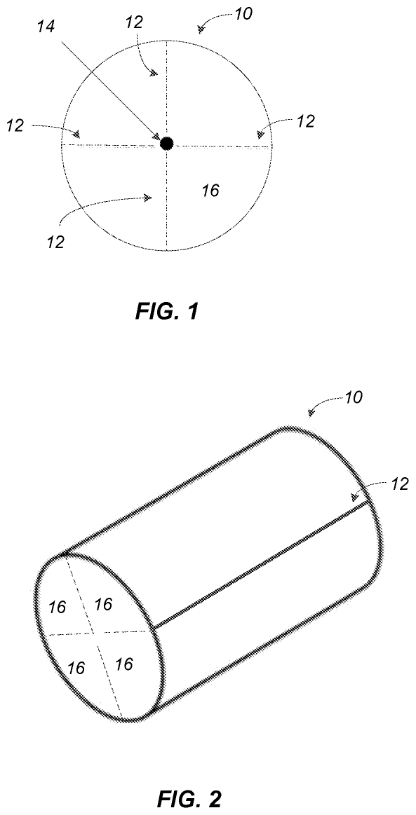

In addition, the corn cobs herein are preferably provided so that they include one or more pre-weakening features such that upon chewing by the animal, the corn cob will itself break apart into one or a plurality of relatively smaller pieces. Such pre-weakening is contemplated to include mechanical pre-weakening, wherein the corn cub is partially cut preferably along and into the corn cob surface. FIG. 1 is a front-view of a generally cylindrical corn cob 10 where it includes four (4) pre-weakening cuts 12. Such pre-weakening cuts preferably extend inwardly in the corn cob, and preferably run along the length of the corn cob, and as illustrated, towards the corn cob center 14 but not completely through the center. As may be appreciated, the corn cob may now preferably include a plurality of pre-weakening cuts, such as 2-25 pre-weakening cuts 12 that extend inwardly from the surface, towards the center, which would then provide that upon chewing by the animal, the corn cob would more readily break into a corresponding plurality of relatively smaller sections 16. FIG. 2 provides a perspective view of the corn cob of FIG. 1.

In addition, it is contemplated that a portion of the interior of the corn cob may be bored out and filled with, e.g., a separate edible formulation optionally containing flavorants, attractants, minerals, and/or vitamins. Such separate edible formulation may preferably be in the form of a liquid and/or paste and may therefore provide a separate incentive for the animal to engage with the corn cob chew.

In addition, the corn cob exterior can be preferably wrapped in another edible composition such as dried meat, such as chicken and/or rawhide. Moreover, the corn cob exterior may preferably be treated with a meat slurry (liquid formulation contain meat) and applied to the corn cob exterior and dried, to leave behind dried chicken, which dried chicken may be preferably configured in a non-uniform coating on the surface of the corn cob. That is, certain sections of the corn cob surface may have relatively greater amounts of the dried meat relative to other sections.

In addition, it is also contemplated herein that the corn cobs themselves including the above referenced one or plurality of enzymes, and optional flavorants, attractants, minerals, and/or vitamins (“corn-cob formulation”) may be granulated or pulverized and then incorporated as a filler material in an edible pet chew, and in particular, a molded pet chew. An edible pet chew is contemplated to include pet chews made of, e.g. starch or rawhide. It is contemplated that the granulated corn cob preferably results in particles having a size of 0.2 mm to 20.0 mm. Pulverized corn cob preferably results in particles with a size in the range of less than 200 microns, or in the range of 5.0 microns to less than 200 microns.

By way of example, the edible pet chew is contemplated to be formed from a starch-based formulation, containing starch, calcium carbonate as a preferred mineral filler, and 0.1% by weight to 50.0% by weight of the granulated or pulverized corn-cob formulation herein, more preferably 0.1% by weight to 25.0% by weight of such granulated or pulverized corn-cob formulation, or 0.1% by weight to 15.0% by weight of such granulated or pulverized corn-cob formulation, or 0.1% by weight to 10.0% by weight of such granulated or pulverized corn-cob formulation, or 0.1% by weight to 5.0% by weight of the granulated or pulverized corn-cob formulation. In such manner, it is preferably contemplated that one may form an edible type pet chew, including starch, calcium carbonate and ground corn cob formulation, where the corn-cob formulation can itself be more readily digested by the animal.

In addition, it is also contemplated that the granulated or pulverized corn cob herein containing one or more enzymes and optional flavorants, attractants, minerals and/or vitamins, may be dispersed in a pet chew formed from a synthetic and/or natural polymer resin, including but not limited to polyethylene, polyamide, polyurethane, polyester, thermoplastic elastomers, polyurethane thermoplastic elastomers and natural or synthetic rubber (polyisoprene). It is contemplated that the level of the granulated or pulverized corn cob herein is present at a level of 0.1% by weight to 25.0% by weight in the synthetic or natural polymer resin that is selected to mold and form a pet chew.

In addition, it is worth noting that the pet chews formed from corn cobs herein, and/or pet chews that include granulated or pulverized corn cob herein, are contemplated to provide improved dental benefits to the pet. That is, the chewing and abrasion by the corn cob and/or corn cob granules and/or pulverized corn cob can serve to assist as a passive method for cleaning the animal's teeth.

The present invention therefore relates to a pet chew comprising a corn cob containing a digestive enzyme. The digestive enzyme is present at a preferred level of 0.1% by weight to 25.0% by weight. The digestive enzyme may include one or a plurality of enzymes. Preferably the enzymes include cellulase, amylase, lipase and/or protease. The corn cob may also include one or more pre-weakening features that promote breakage of the corn cob when chewed upon by the pet. The corn cob containing the one or more digestive enzymes may be granulated or pulverized and serve as an additive for an edible pet chew or as an additive in a synthetic and/or natural polymer resin.

1. A pet chew comprising a corn cob containing one or more digestive enzymes.

2. The pet chew of claim 1 wherein said one or more digestive enzymes is present at a level of 0.1% by weight to 50.0% by weight.

3. The pet chew of claim 1 wherein said one or more digestive enzymes are selected from cellulase, amylase, lipase or protease.

4. The pet chew of claim 1 wherein said one or more digestive enzymes comprises at least two digestive enzymes selected from cellulase, amylase, lipase or protease.

5. The pet chew of claim 1 wherein said one or more digestive enzymes comprises at least three digestive enzymes selected from cellulase, amylase, lipase or protease.

6. The pet chew of claim 1 wherein said one or more digestive enzymes comprises cellulase, amylase, lipase and protease.

7. The pet chew of claim 1 further including one or more flavorants, oils, attractants, minerals or vitamins.

8. The pet chew of claim 1 wherein said corn cob includes one or more pre-weakening features which upon chewing by an animal, the corn cob breaks apart into one or a plurality of relative smaller pieces.

9. The pet chew of claim 1 wherein said corn cob has a surface and said surface includes dried meat.

10. An edible pet chew comprising granulated or pulverized corn cobs containing one or more digestive enzymes.

11. The pet chew of claim 10 wherein said one or more digestive enzymes is present at a level of 0.1% by weight to 50.0% by weight.

12. The edible pet chew of claim 10 wherein said edible pet chew comprises starch.

13. A pet chew comprising granulated or pulverized corn cobs containing one or more digestive enzymes dispersed in a polymeric resin.

14. The pet chew of claim 13 wherein said polymeric resin is selected from polyethylene, polyamide, polyurethane, polyester, thermoplastic elastomers, natural or synthetic rubber.

15. The pet chew of claim 13 wherein said granulated or pulverized corn cobs containing one or more digestive enzymes is present in said polymeric resin at a level of 0.1% by weight to 50.0% by weight.
